(19) United States
(12) Patent Application Publication
(10) Pub. No.: US 2002/0164043 A1
(43) Pub. Date: Nov. 7, 2002

(54) Directional optical microphones

(76) Inventors: Alexander Paritsky, Modi'In (IL); Alexander Kots, Ashdod (IL)

Correspondence Address: G E Ehrlich 1995, Antonhy Castorina, Suite 207, 2001 Jefferson Davis Highway, Arlington, VA, 22202, US

(21) Appl. No.: 10/129,731

(22) PCT Filed: Sep. 10, 2001
(86) PCT No.: PCT/IL01/00853

(30) Foreign Application Priority Data
Sep. 14, 2000 (IL) 138460

(51) Int. Cl. H04R 9/08; H04R 11/04; H04R 17/02; H04R 3/00

(52) U.S. Cl. 381/356; 381/172; 381/91; 381/92

(57) ABSTRACT

The invention provides a directional optical microphone, including a housing having an open wall portion closed by a membrane attached thereto, the membrane having an outer surface and an inner surface facing the inside of the housing; a first light waveguide accommodated within the housing, having an output end portion for transmitting light towards the inner surface of the membrane, and a second light waveguide having an input end portion for receiving light reflected from the inner surface; the output and input end portions being positioned in close proximity to, and in optical isolation from, each other, and at least one aperture made in a wall of the housing, the aperture having a cross-sectional area of not less than 1 mm², for admitting sound waves into the housing to impinge on the inner surface of the membrane.

### FIELD OF THE INVENTION

The present invention relates to optical microphones, and more particularly, to directional optical microphones.

### BACKGROUND OF THE INVENTION

Optical microphones comprise a housing, at least one pair of light waveguides, at least one source of light, at least one photodetector, and a membrane onto which light is directed.

In comparison with the known sensor construction which is less suitable for microphone use, the directional optical microphone possesses better direction characteristics, is much more sensitive, and may be used as a close talk microphone for distances as close as 1-5 cm, or as a far talk directional microphone for distances up to 50-70 cm.

The main deficiencies of known directional microphones are their relatively low sensitivity at greater distances and the proximity effect that changes their frequency characteristics with the distance between the microphone and the source of sound. Directional optical microphones overcome these deficiencies; their construction enables compensation of the proximity effect for distances up to 70 cm.

### DISCLOSURE OF THE INVENTION

It is therefore a broad object of the present invention to provide an optical microphone possessing high sensitivity and the directional characteristics of a figure-eight.

It is another broad object of the present invention to provide a optical microphone having good proximity effect compensation.

According to the present invention, there is therefore provided a directional optical microphone, comprising a housing having an open wall portion closed by a membrane attached thereto, said membrane having an outer surface and an inner surface facing the inside of said housing; a first light waveguide accommodated within said housing, having an output end portion for transmitting light towards the inner surface of said membrane, and a second light waveguide having an input end portion for receiving light reflected from said inner surface; said output and input end portions being positioned in close proximity to, and in optical isolation from, each other, and at least one aperture made in a wall of said housing, said aperture having a cross-sectional area of not less than 1 mm², for admitting sound waves into said housing to impinge on the inner surface of said membrane.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross-sectional view of an optical microphone according to the present invention, having regular, pyramid-shaped light waveguides;

FIG. 2 is a cross-sectional view of an optical microphone according to the present invention, having stepped light waveguides;

FIG. 3 illustrates the frequency characteristics of a figure-eight microphone having proximity effect;

FIG. 4 illustrates the frequency characteristics of an optical microphone having damping effect, and

FIG. 5 illustrates the frequency characteristics of an optical microphone according to the present invention, after correction of the proximity effect by the damping effect.

### DETAILED DESCRIPTOIN OF PREFERRED EMBODIMENTS

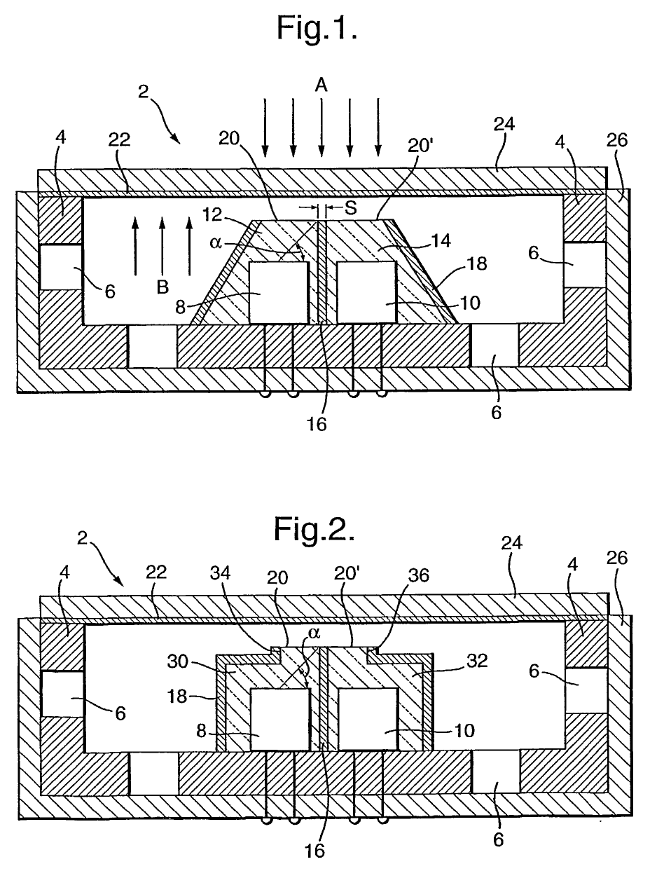

FIG. 1 depicts a directional optical microphone 2 according to the present invention, including a housing 4 having acoustical apertures 6, each of a cross-sectional area of not less than 1 mm², and preferably between 1.5-2.5 mm². The optical microphone further includes a light source 8, e.g., an LED, a photodetector 10, a pair of light waveguides 12, 14 positioned adjacent to each other and mechanically connected by a thin, opaque partition 16 forming a pyramid-shaped configuration covered on its sides by an opaque material 18 and uncovered at its upper surfaces 20, 20′. There is also provided an acoustical membrane 22 affixed to housing 4. Membrane 22 and acoustical apertures 6 are advantageously covered by acoustical filters 24, 26 made, e.g., of sponge or felt material, for reducing the influence of wind on the microphone. Acoustical apertures 6 enable sound to enter the housing 4 and to impinge upon membrane 22, not only from the front of the membrane, i.e., from the direction A outside housing 4, but also from the back of the membrane 22, i.e., from the direction B inside the housing 4. This possibility makes the microphone bi-directional, or direction-sensitive, to sounds from directions substantially perpendicular to the plane of the membrane, and almost insensitive to sounds from directions substantially parallel to the plane of the membrane.

In order to increase the sensitivity of the directional optical microphone in comparison with known optical microphones, the proposed construction enables selective separation by a distance S between the upper surfaces 20, 20′ of both light waveguides 12, 14. The upper surface area of the pyramid is made as small as possible, and about 150-200 μ². In addition, the source of light 8 is advantageously positioned relative to partition 16 so that the angle a between the center of the surface of light source 8 and the upper edge of partition 16 will equal, or be less than, the total internal reflection angle for the specific material of the light waveguide 12, and also that the opaque partition 16 is very thin, e.g., not more than several microns in thickness. The position of photodetector 10 is symmetrical with respect to the position of the light source 8 relative to the opaque partition 16. Advantageously, the combined surface area of the surfaces 20, 20′ should be between 5-15% of the surface area of the inner surface of membrane 22. All of these features render the optical microphone much more sensitive than prior art microphones.

To prevent the penetration of light directly from the light waveguide 8 to light waveguide 10 without reflection by membrane 22, the pyramid-shaped sides. of waveguides 12, 14 are covered by the opaque material 18. For this purpose, it may be sufficient to cover only one of the sides of the pyramid.

Light produced by source 8 passes through waveguide 12, exits through its upper surface 20, impinges upon the inner surface of, and is reflected by, membrane 22 and returns through surface 20′ via waveguide 14 to photodetector 10. Photodetector 10 registers the intensity of the light reflected by membrane 22, which is a function of the membrane's absolute position with respect to surfaces 20, 20′. Under the influence of the prevailing sound pressure, the position of the membrane is changed and the reflected light intensity is changed likewise. That leads to modulation of the light intensity at photodetector 10 and to modulation of the output electrical signal from the photodetector.

FIG. 2 illustrates a microphone according to the present invention, having a slightly modified configuration of the waveguides. Seen are waveguides 30, 32, having a stepped, cylindrical configuration resulting from the shoulders 34, 36 formed at their upper portions. Otherwise, the structure and function of the microphone are substantially the same as those of the embodiment of FIG. 1. The waveguides may alternatively be configured as a stepped pyramid.

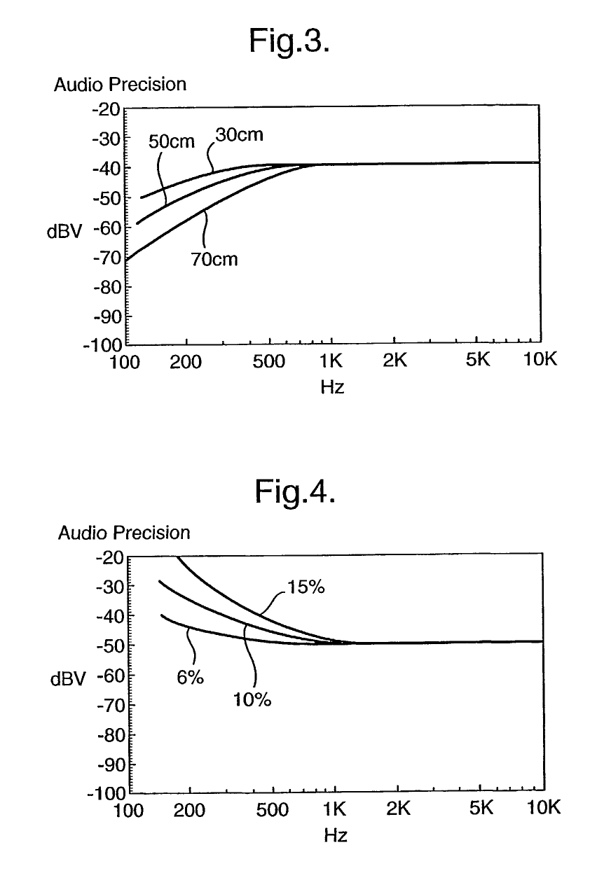

FIG. 3 shows the typical proximity characteristics of a figure-eight directional microphone. Every directional microphone measures the differences in acoustical pressures on both sides of its membrane. As a result, for long acoustical waves, i.e., for low frequencies, the pressure difference between two points in the space will be smaller than that for short acoustical waves of higher frequencies. That is why the frequency characteristics of a directional microphone possess a roll-off at low frequencies, e.g., from 1 kHz and down. Such microphones are not used for receiving distance waves, but are usually used as lip microphones at short distances of, e.g., up to 1-4 cm only.

FIG. 4 shows damping characteristics of an optical microphone. Damping is connected with the aerodynamic relationship between movements of the membrane and the upper surface of the waveguides. Because the space between the membrane and the surface of the waveguides is very small, during the membrane's movements, the air in the space does not have sufficient time to exit and so produces a so-called “damping” effect which prevents the free movement of the membrane. The damping effect is higher at higher frequencies and lower at lower frequencies. That is why a microphone has higher sensitivity at lower frequencies, and lower sensitivity at higher frequencies.

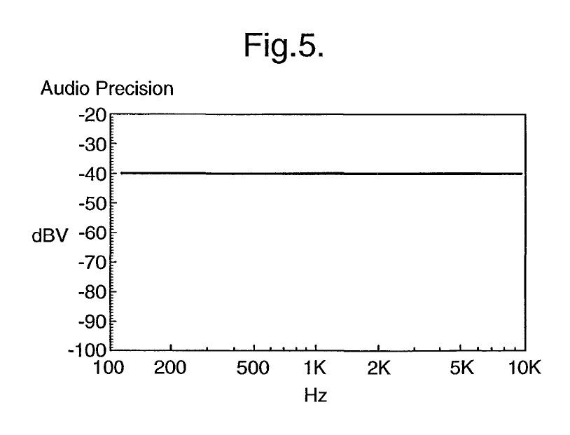

The damping effect may be changed by changing the size of the upper surface of the waveguides. The sensitivity of an optical microphone at different frequencies may be changed in this manner. Utilizing the damping effect characteristics of a directional optical microphone will correct its proximity characteristics; thereby, the frequency characteristics of the microphone may be made as linear as required (FIG. 5).

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A directional optical microphone, comprising:
a housing having an open wall portion closed by a membrane attached thereto, said membrane having an outer surface and an inner surface facing the inside of said housing;
a first light waveguide accommodated within said housing, having an output end portion for transmitting light towards the inner surface of said membrane, and a second light waveguide having an input end portion for receiving light reflected from said inner surface; said output and input end portions being positioned in close proximity to, and in optical isolation from, each other, and
at least one aperture made in a wall of said housing, said aperture having a cross-sectional area of not less than 1 mm², for admitting sound waves into said housing to impinge on the inner surface of said membrane.

2. The microphone as claimed in claim 1, further comprising an acoustical filter covering the outside surface of said membrane.

3. The microphone as claimed in claim 1, farther comprising an acoustical filter covering said aperture in the wall of said housing.

4. The microphone as claimed in claim 1, wherein at least said output end portion and input end portion of said first and second light waveguides are conically-shaped solid bodies having an upper surface and side surfaces.

5. The microphone as claimed in claim 4, wherein the upper surfaces of said waveguides have a surface area of about 150-200 μ².

6. The microphone as claimed in claim 4, wherein the combined surface area of said upper surfaces is between 5-15% of the surface area of the inner surface of said membrane.

7. The microphone as claimed in claim 4, wherein said waveguides, when positioned in close proximity to each other, form a pyramid.

8. The microphone as claimed in claim 1, wherein at least said output end portion and input end portion of said first and second light waveguides are shaped with a shoulder and, when placed in close proximity to each other, form a stepped cylinder.

9. The microphone as claimed in claim 7, wherein said pyramid is covered with an opaque material on at least one of its sides.

10. The microphone as claimed in claim 1, wherein the input and output end portions of said waveguides are solid bodies separated by an opaque partition.

11. The microphone as claimed in claim 10, wherein a source of light is embedded in said output end portion and a photodetector is embedded in said input end portion.

12. The microphone as claimed in claim 11, wherein said source of light is positioned relative to said partition so that the angle between the center of the light source and the upper edge of said partition will be equal to or less than the angle of total internal reflection for the specific material of which the waveguide is made.
